(19) United States
(12) Patent Application Publication
(10) Pub. No.: US 2012/0242010 A1
(43) Pub. Date: Sep. 27, 2012

(54) NANOFIBER MANUFACTURING APPARATUS AND METHOD OF MANUFACTURING NANOFIBERS

(76) Inventors: Kazunori Ishikawa, Osaka (JP); Hiroto Sumida, Nara (JP); Takahiro Kurokawa, Osaka (JP)

(21) Appl. No.: 13/514,098

(22) PCT Filed: Dec. 6, 2010
(86) PCT No.: PCT/JP2010/007087

§ 371 Date: Jun. 6, 2012

(30) Foreign Application Priority Data
Dec. 10, 2009 (JP) 2009-280855

(51) Int. Cl. B29C 55/00

(52) U.S. Cl. 264/479; 425/174.8 E

(57) ABSTRACT

A deposit of nanofibers which has an even thickness and even quality is produced. A nanofiber manufacturing apparatus according to the present invention includes: an effusing body (115) which has an effusing hole (118) through which a solution (300) is effused; a charging electrode (128); a charging power supply (122) which applies a given voltage between the effusing body (115) and the charging electrode (128); a drawing electrode (121) which draws nanofibers (301) produced in space, the drawing electrode (121) having, on a surface, a planar deposition region (A) onto which the drawn nanofibers (301) are deposited; a drawing power supply (123) which applies a given potential to the drawing electrode (121); and an insulating layer (101) which suppresses variation in resistance values of the nanofibers deposited in the deposition region (A) and is placed throughout the deposition region (A).

### TECHNICAL FIELD

The present invention relates to a nanofiber manufacturing apparatus and a method of manufacturing nanofibes which produces fibers having diameters of submicron order or nanometer order (referred to as nanofibers in this description) by electrostatic stretching.

### BACKGROUND ART

There is a known method of manufacturing filamentous (fibrous) substances containing a resin and having a submicron- or nanometer-scale diameter by making use of electrostatic stretching (electrospinning).

The electrostatic stretching is a method of manufacturing nanofibers. In the method, a solution prepared by dispersing or dissolving a solute such as a resin in a solvent is effused (ejected) into space through a nozzle or the like, and the solution is charged and electrically stretched in flight so that nanofibers are produced.

The following describes the electrostatic stretching more specifically. The solvent gradually evaporates from the charged solution while the solution effused into space is in flight. The volume of the solution in flight thus gradually decreases while the charges imparted to the solution stays in the solution. As a result, the charge density of the solution in flight gradually increases. The solvent ongoingly evaporates and the charge density of the solution further increases, and the solution is explosively stretched into a line when the Coulomb force generated in the solution and repulsive to the surface tension of the solution surpasses the surface tension. This is how the electrostatic stretching occurs. The electrostatic stretching exponentially occurs in space one after another so that nanofibers having diameters of sub-micron orders or nanometer orders are produced.

When nanofibers are produced by such electrostatic stretching, an apparatus as disclosed in Patent Literature 1 (hereinafter referred to as PTL 1) is used. The apparatus includes a nozzle that effuses a solution into space and an electrode which is arranged separately from the nozzle, and a high voltage is applied between the nozzle and the electrode. The nanofibers produced in space are drawn into an electric field that is generated between the nozzle and the electrode, and are deposited on the electrode.

When the deposited nanofibers are used for unwoven fabric and the like, there is a case that a problem occurs in evenness in a deposition state, namely, the evenness in the thickness of the overall unwoven fabric and the evenness in the density of the nanofibers that are included in the unwoven fabric. In the nanofibers manufacturing apparatus disclosed in PTL 1, plural nozzles are arranged in a matrix and a control board or the like is arranged between the nozzles so as to suppress electrical effects between the nozzles, thereby making the nanofibers to be deposited evenly.

### CITATION LIST

### Patent Literature

[PTL 1] Japanese Unexamined Patent Application Publication No. 2008-174867

### SUMMARY OF INVENTION

### Technical Problem

However, as a result of continuous experiments and researches for improving the evenness in the deposition state of the nanofibers, the inventors of the present application have found that the evenness in the deposition state of the nanofibers is deteriorated not only depending on the form or the arrangement of the effusing body, such as the nozzle through which the solution effuses, but also depending on a state of the electrode onto which the nanofibers are deposited. For example, the inventors have found that the evenness in the deposition state of the nanofibers is deteriorated when the nanofibers are deposited on an insulating deposition member arranged on the electrode side. The inventors have also found that such a phenomenon is caused by unevenness in a charged state of the deposition member. Furthermore, the inventors have found that, even when the nanofibers are deposited not via the deposition member but directly onto the electrode, the evenness in the deposition state is severely deteriorated as the nanofibers are deposited. This is because the nanofibers that have fallen earlier change the state in the electrode side (cause non-uniformity in the charge on the electrode) to adversely affect nanofibers that fall later, because the nanofibers gradually fall and are deposited onto the electrode.

The present invention is conceived in view of the above findings and has an object to provide a nanofiber manufacturing apparatus and a method of manufacturing nanofibes capable of depositing nanofibers while keeping a high evenness in the deposition state.

### Solution to Problem

In order to achieve the above objective, a nanofiber manufacturing apparatus according to the present invention produces nanofibers by electrically stretching in space a solution for manufacturing nanofibers, the apparatus including: an effusing body which has an effusing hole through which the solution is effused into space; a charging electrode which is arranged at a given distance from the effusing body and charges the effusing body; a charging power supply which applies a given voltage between the effusing body and the charging electrode; a drawing electrode which generates an electric field that draws the nanofibers produced in space, the drawing electrode having, on a surface, a planar deposition region onto which the drawn nanofibers are deposited; a drawing power supply which applies a given potential to the drawing electrode; and an insulating layer which is a surface of the drawing electrode and is placed throughout the deposition region.

Thus, the insulating layer intervenes between the nanofibers that are being deposited and the drawing electrode so that the charges are deterred from flowing between the nanofibers and the drawing electrode in part of the deposition region and the charges in the deposition region are deterred from being uneven. Accordingly, charges remained in the nanofibers have an even density throughout the deposition region so that it is possible to draw the nanofibers in an even state without disturbing the electric field generated from the drawing electrode and to deposit the nanofibers in an even state.

In order to achieve the above objective, a method of manufacturing nanofibes according to the present invention is a method of manufacturing nanofibes by electrically stretching in space a solution for manufacturing nanofibers, the method including: effusing the solution from an effusing body having an effusing hole through which the solution is effused into space; applying, by a charging power supply, a given voltage between the effusing body and a charging electrode which is arranged at a given distance from the effusing body and charges the effusing body; and applying, by a drawing power supply, a given potential to a drawing electrode so that the nanofibers produced in space are drawn into and deposited onto a deposition region onto which the nanofibers are deposited, the drawing electrode having an insulating layer hat has the deposition region in a plane form and is placed throughout the deposition region.

Thus, the insulating layer intervenes between the nanofibers that are being deposited and the drawing electrode so that the charges are deterred from flowing between the nanofibers and the drawing electrode in part of the deposition region and the charges in the deposition region are deterred from being uneven. Accordingly, charges remained in the nanofibers have an even density throughout the deposition region so that it is possible to draw the nanofibers in an even state without disturbing the electric field generated from the drawing electrode and to deposit the nanofibers in an even state.

### ADVANTAGEOUS EFFECTS OF INVENTION

The present invention enables to further deposit nanofibers with less influence from the charged state of the nanofibers deposited onto the drawing electrode earlier, thereby enabling manufacture of unwoven fabrics having an even quality throughout the deposition region.

### BRIEF DESCRIPTION OF DRAWINGS

FIG. 1 is a perspective view illustrating a nanofiber manufacturing apparatus.

FIG. 2 is a side view illustrating a cutaway of a part of a main portion of the nanofiber manufacturing apparatus.

FIG. 3 is a perspective view illustrating a cutaway of an effusing body.

FIG. 4 is a perspective view illustrating the nanofiber manufacturing apparatus.

FIG. 5 is a side view illustrating a cutaway of a part of the main portion of the nanofiber manufacturing apparatus.

FIG. 6 (a) in FIG. 6 is a perspective view illustrating another example of the effusing body, and (b) in FIG. 6 is a side view illustrating a cutaway of a part of another example of the effusing body.

FIG. 7 is a perspective view illustrating a nanofiber manufacturing apparatus according to another embodiment.

FIG. 8 is a perspective view illustrating a nanofiber manufacturing apparatus according to yet another embodiment.

FIG. 9 is a plan view illustrating one of varieties of a relation among an insulating layer, a drawing electrode, and a deposition member from a side.

FIG. 10 is a plan view illustrating one of varieties of the relation among the insulating layer, the drawing electrode, and the deposition member from a side.

FIG. 11 is a plan view illustrating one of varieties of the relation among the insulating layer, the drawing electrode, and the deposition member from a side.

FIG. 12 is a plan view illustrating one of varieties of the relation among the insulating layer, the drawing electrode, and the deposition member from a side.

### DESCRIPTION OF EMBODIMENTS

The following describes a nanofiber manufacturing apparatus and a method of manufacturing nanofibes according to the present invention with reference to the drawings.

### Embodiment 1

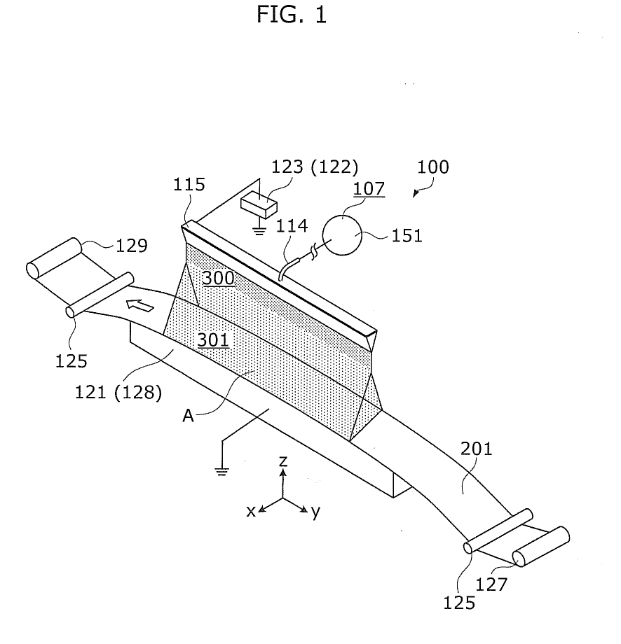

FIG. 1 is a perspective view illustrating the nanofiber manufacturing apparatus.

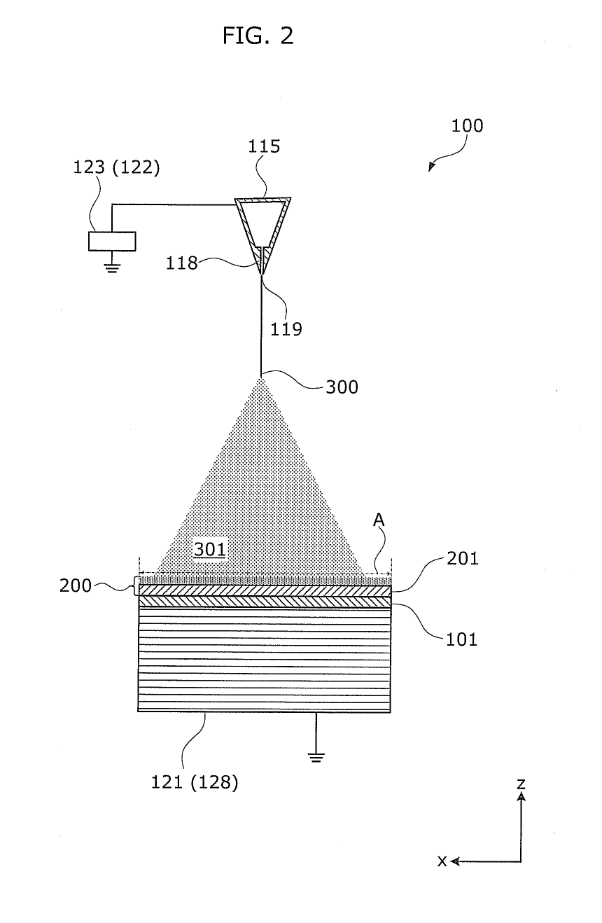

FIG. 2 is a side view illustrating a cutaway of a part of a main portion of the nanofiber manufacturing apparatus.

As shown in the drawings above, the nanofiber manufacturing apparatus 100 is an apparatus which produces nanofibers 301 by electrically stretching in space a solution 300 for producing nanofibers 301, and includes an effusing body 115, a charging electrode 128, a charging power supply 122, a drawing electrode 121, a drawing power supply 123, and an insulating layer 101.

In the present invention, the drawing electrode 121 also functions as a charging electrode 128. That is, a single electrode functions as both the drawing electrode 121 and the charging electrode 128. Furthermore, the drawing power supply 123 also functions as a charging power supply 122. That is, a single power supply functions as both the drawing power supply 123 and the charging power supply 122.

Furthermore, although the solution 300 and the nanofibers 301 are distinguished and described in Description and Drawings for convenience, the boundary between the solution 300 and the nanofibers 301 is not necessarily definite because the nanofibers 301 are gradually produced from the solution 300 in the manufacturing process of the nanofibers 301, namely, in the phase that the electrostatic stretching is occurring.

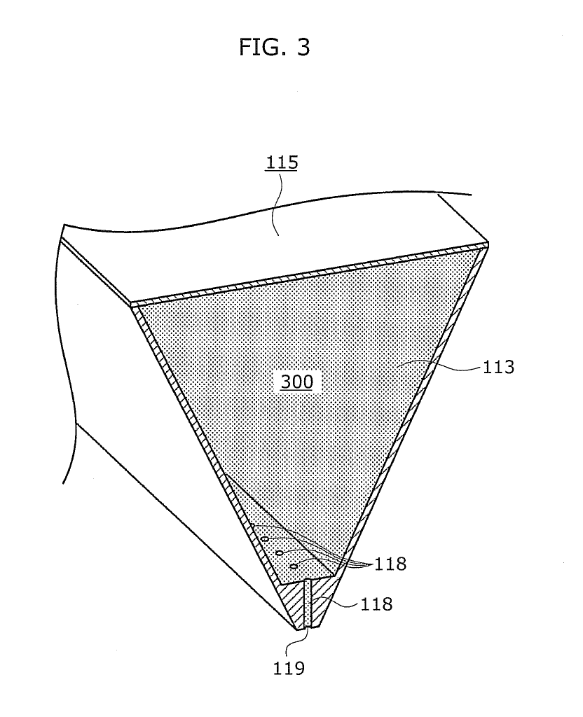

FIG. 3 is a perspective view illustrating a cutaway of the effusing body.

The effusing body 115 is a member for effusing the solution 300 into space by the pressure (and the gravity in some cases) of the solution 300, and includes an effusing hole 118 and a storage tank 113. The effusing body 115 also includes a conductive member on at least part of the surface in contact with the solution 300 so as to function as an electrode to provide charges to the solution 300 which effuses from the effusing body 115. In the present embodiment, the effusing body 115 is made of metal in whole. The metal to be used as a material for the effusing body 115 is not limited to a specific type of metal and may be any conductive metal such as brass or stainless steel.

The effusing hole 118 is a hole for effusing the solution 300 in a constant direction. In the present embodiment, plural effusing holes 118 are provided in the effusing body 115 such that tip openings 119 formed in tips of effusing holes 118 are arranged to form an array on a surface which is in an elongated strip form and included in the effusing body 115. The effusing holes 118 are provided in the effusing body 115 such that an effusing direction of the solution 300 which effuses from the effusing holes 118 is the same direction as the effusing body 115.

The effusing holes 118 do not have a specifically limited length or diameter and are formed to have a shape appropriate for the viscosity of the solution 300 or the like. Specifically, the effusing holes 118 preferably have a length within a range from 1 mm to 5 mm. The effusing holes 118 preferably have a diameter within a range from 0.1 mm to 2 mm. The shape of the effusing holes 118 is not limited to a cylindrical shape and any shape may be selected for the shape as necessary. In particular, the shape of the tip openings 119 is not limited to a circular shape and may be a polygonal shape such as a triangle or a quadrilateral, and even a concave shape such as a star polygon. Furthermore, the effusing body 115 may be movable with respect to the charging electrode 128.

In the present embodiment, as shown in FIG. 1, the nanofiber manufacturing apparatus 100 includes a supplying device 107. The supply unit 107 includes a container 151, a pump (not shown in the drawing), and a guide tube 114 to supply the solution 300 to the effusing body 115. The container 151 stores the solution 300 in large quantity. The pump transfers the solution 300 with a given pressure. The guide tube 114 guides the solution 300.

The drawing electrode 121 is an electrode that generates an electric field that draws the nanofibers 301 produced in space and has, on the surface, a planar deposition region A onto which the drawn nanofibers 301 are deposited. In the present embodiment, the drawing electrode 121 is arranged at a given distance from the effusing body 115, and also functions as the charging electrode that is a member to which a high voltage is applied between the effusing body 115. That is, the drawing electrode 121 is also a member which collects charges into the effusing body 115 and charges the solution 300, by the high voltage applied between the effusing body 115 and the drawing electrode 121 that functions as the charging electrode 128.

Specifically, the drawing electrode 121 (charging electrode 128) is a member which includes a conductor in a block form and has, on one surface, a curved surface that is gently convex toward the effusing body 115 (z axis direction). In the present embodiment, the charging electrode 128 is grounded. By curving the drawing electrode 121 (charging electrode 128), the deposition member 201 (described later) placed on the drawing electrode 121 (charging electrode 128) can also be curved so that the portion onto which the nanofibers 301 are deposited becomes convex. Thus, the deposition member 201 is prevented from being warped by the contraction of the nanofibers 301 after being deposited on the deposition member 201.

The drawing electrode 121 (charging electrode 128) is not limited to be in a curved form but may be in a planer surface.

The drawing power supply 123 is a power supply that applies a given potential to the drawing electrode 121. In the present embodiment, the drawing power supply 123 also functions as the charging power supply 122 that is capable of applying a high voltage between the effusing body 115 and the drawing electrode 121 (charging electrode 128). The drawing power supply 123 (charging power supply 122) is a direct-current power supply, and the voltage that is applied by the drawing power supply 123 (charging power supply 122) is preferably set from a value within a range from 5 kV to 100 kV.

By setting one of electrodes of the drawing power supply 123 (charging power supply 122) at a ground potential and grounding the drawing electrode 121 (charging electrode 128), as in the present embodiment, a relatively large drawing electrode 121 (charging electrode 128) can be grounded so that safety can be improved.

By allowing a single conductive member to have the functions of both the drawing electrode 121 and the charging electrode 128, the structure of the nanofiber manufacturing apparatus 100 can be simplified. Thus, the portion to which the high voltage is applied is simplified and sufficient safety is kept even when a simple insulating structure is adopted, so that costs for the apparatus can be reduced.

The solution 300 may be charged by grounding the effusing body 115 and keeping the drawing electrode 121 (charging electrode 128) at a high voltage with a power supply connected to the drawing electrode 121 (charging electrode 128). The drawing electrode 121 (charging electrode 128) and the effusing body 115 are not necessarily grounded.

The insulating layer 101 (see FIG. 2) is a layer which is for suppressing variation in resistance values caused by the deposited nanofibers 301 in the deposition region A, has an insulation property, and is arranged over the whole deposition region A. In the present embodiment, the insulating layer 101 is a layer which is for suppressing the variation in resistance values so that the variation is within a tolerance, an insulator which is placed in a film form and in contact with a surface of the drawing electrode 121 (charging electrode 128) continuously, and a member that is arranged over the whole deposition region A, the variation in resistance values being caused by the substrate layer 200 and the deposited nanofibers 301.

Although the material included in the insulating layer 101 is not specifically limited, it is preferable that a substance having a volume resistivity of 1×10̂15 (Q·cm) (̂ represents exponentiation) is included. Including a substance having a high volume resistivity in the insulating layer 101 as described above enables to keep high thickness resistance values even when the insulating layer 101 is thin, the thickness resistance values being resistance values in the thickness direction (z axis direction). This is how charges are deterred from flowing between the nanofibers 301 and the drawing electrode 121 (charging electrode 128) in part of the deposition region so that charges in the deposition region of the nanofibers 301 are deterred from being uneven, without largely affecting the electric field that is generated between the effusing body 115 and the drawing electrode 121 (charging electrode 128).

Particularly, the volume resistivity of the material included in the insulating layer 101 is preferably equal to or greater than ten times the volume resistivity of the material (solute) included in the nanofibers 301 or the deposition member 201.

When the volume resistivity of the nanofibers 301 that are being deposited and the volume resistivity of the insulating layer 101 have a gap of greater than or equal to 10 times therebetween as described above, the variation in resistance values of both the insulating layer 101 and the thickness in the whole deposition region A can be small enough to be ignored, even in a state that the nanofibers 301 have been deposited to some extent. Accordingly, the charged amount in the whole deposition region A is approximately even, and the nanofibers 301 that are deposited later can be evenly deposited in the deposition region A. This enables to produce the unwoven fabric that is the deposit of the nanofibers 301 having an even quality throughout the deposition region A.

Although it has been described above that it is preferable that the volume resistivity of the material included in the insulating layer 101 is equal to or greater than ten times the volume resistivity of the material (solute) included in the nanofibers 301 or the deposition member 201, it is also preferable that the thickness resistance values are equal to or greater than ten times the thickness resistance values of the nanofibers 301 or the deposition member 201, the thickness resistance values being resistance values of the insulating layer 101 in the thickness direction (z axis direction). Such a condition also enables to produce the unwoven fabric that is the deposit of the nanofibers 301 having an even quality throughout the deposition region A.

The material included in the insulating layer 101 preferably includes a substance having a dielectric strength of greater than or equal to 20 (kV/mm). A voltage applied between the effusing body 115 and the drawing electrode 121 (charging electrode 128) is preferably within a range from 5 kV to 100 kV. Therefore, when a substance having a dielectric strength of less than 20 (kV/mm) is included in the insulating layer 101, a possibility of dielectric breakdown increases and stability in quality of the nanofibers 301 in the deposition region A may not be kept.

Examples of preferable material included in the insulating layer 101 include polyethylene, polypropylene, PTFE, vinyl chloride, and silicon rubber. The silicon rubber is particularly preferable for its adjustability to a characteristic that matches the condition above.

The substrate layer 200 is a layer onto which the nanofibers 301 produced in space are deposited, and is arranged on the surface of the insulating layer 101 so as to cover the deposition region A. Accordingly, the nanofibers 301 that have already deposited are also included in the substrate layer 200.

In the present embodiment, the substrate layer 200 also includes the deposition member 201 for collecting the deposited nanofibers 301. The deposition member 201 is an insulating member in a sheet form which is movable and is provided in a state being rolled around the supplying role 127. The deposition member 201 can be moved by being rolled by a collecting device 129 in a direction indicated by an arrow in FIG. 1. Furthermore, the deposition member 201 is arranged along the curve of the drawing electrode 121 (charging electrode 128) and movably fastened from above by rotatably mounted fastening members 125 each of which is in a bar-like form and arranged near an end edge of the drawing electrode 121 (charging electrode 128).

Although an advance direction of the deposition member 201 is illustrated as if it matches an arrangement direction of the effusing holes 118 in FIG. 1, the advance direction of the deposition member 201 is not limited to the above. For example, the advance direction of the deposition member 201 may be along a direction perpendicular to the arrangement direction of the effusing holes 118 (longitudinal direction of the effusing body 115).

In the nanofiber manufacturing apparatus 100 having the apparatus structure as described above, it is preferable that the insulating layer 101 is a layer that is able to keep satisfying the following equation until the thickness of the nanofibers that are being deposited reach a desired thickness. That is, the insulating layer 101 and the deposition member 201 satisfies (rmax−rmin)/R≦k, where rmax is the maximum value of “total thickness resistance values”, rmin is the minimum value of the total thickness resistance values in the deposition region, R is an average value of the total thickness resistance values in the deposition region, and k is an allowable value of the variation, the “total thickness resistance values” being resistance values in a thickness direction of both the insulating layer 101 and the deposition member 201.

The above allowable value k of the variation is different depending on a specification required for the unwoven fabric obtained by depositing the nanofibers 301. However, for example, it is preferable that the allowable value k is smaller than or equal to 0.1, and further, it is sufficient that the allowable value k is smaller than or equal to 0.3.

When the thickness resistance values of the insulating layer 101 is sufficiently high as compared with the thickness resistance values of the deposition member 201 or the deposited nanofibers 301, and the thickness resistance values of the insulating layer 101 is sufficiently even in the deposition region A, the insulating layer 101 can satisfy the above equation.

The following describes a method of manufacturing the nanofibers 301 using the nanofiber manufacturing apparatus 100 having the above structure.

First, the supply unit 107 supplies the solution 300 to the effusing body 115 (a supply step). The storage tank 113 of the effusing body 115 is thus filled with the solution 300.

Here, examples of a resin included in the nanofibers 301 that is a solute dissolvable or dispersible into the solution 300 include high-molecular substances such as polypropylene, polyethylene, polystyrene, polyethylene oxide, polyethylene terephthalate, polybutylene terephthalate, polyethylene naphthalate, poly-m-phenylene terephthalate, poly-p-phenylene iso phthalate, polyvinylidene fluoride, polyvinylidene fluoride-hexafluoropropylene copolymer, polyvinyl chloride, polyvinylidene chloride-acrylate copolymer, polyacrylonitrile, polyacrylonitrile-methacrylate copolymer, polycarbonate, polyarylate, polyester carbonate, polyamide, aramid, polyimide, polycaprolactone, polylactic acid, polyglycolic acid, collagen, polyhydroxybutyric acid, polyvinyl acetate, polypeptide, and a copolymer thereof. The resin may be the one selected from among the above substances or a mixture thereof. The substances are given for illustrative purposes only and the present invention is not determined by the resins above.

Examples of the solvent to be used as the solution 300 include volatile organic solvents. Specific examples of the solvent include methanol, ethanol, 1-propanol, 2-propanol, hexafluoroisopropanol, tetraethylene glycol, triethylene glycol, dibenzyl alcohol, 1,3-dioxolane, 1,4-dioxane, methyl ethyl ketone, methyl isobutyl ketone, methyl-n-hexyl ketone, methyl-n-propyl ketone, diisopropyl ketone, diisobutyl ketone, acetone, hexafluoroacetone, phenol, formic acid, methyl formate, ethyl formate, propyl formate, methyl benzoate, ethyl benzoate, propyl benzoate, methyl acetate, ethyl acetate, propyl acetate, dimethyl phthalate, diethyl phthalate, dipropyl phthalate, methyl chloride, ethyl chloride, methylene chloride, chloroform, o-chlorotoluene, p-chlorotoluene, chloroform, carbon tetrachloride, 1,1-dichloroethane, 1,2-dichloroethane, trichloroethane, dichloropropane, dibromoethane, dibromopropane, methyl bromide, ethyl bromide, propyl bromide, acetic acid, benzene, toluene, hexane, cyclohexane, cyclohexanone, cyclopentane, o-xylene, p-xylene, m-xylene, acetonitrile, tetrahydrofuran, N,N-dimethylformamide, NM-dimethylacetamide, dimethyl sulfoxid, pyridine, and water. The solvent may be the one selected from among the above substances or a mixture thereof. The solvent are given for illustrative purposes only and the solution 300 used in the present invention is not limited to the solvents above.

In addition, an inorganic solid material may be added to the solution 300. The inorganic solid material may be an oxide, a carbide, a nitride, a boride, a silicide, a fluoride, or a sulfide. However, in view of preferable properties, such as thermal resistance and workability, of the nanofibers 301 to be manufactured, an oxide is preferable among them. Examples of the additive include Al₂O₃, SiO₂, TiO₂, Li₂O, Na₂O, MgO, CaO, SrO, BaO, B₂O₃, P₂O₅, SnO₂, ZrO₂, K₂O, Cs₂O, ZnO, Sb₂O₃, As₂O₃, CeO₂, V₂O₅, Cr₂O₃, MnO, Fe₂O₃, COO, NiO, Y₂O₃, Lu₂O₃, Yb₂O₃, HfO₂, and Nb₂O₅. The inorganic solid material may be the one selected from among the above substances or a mixture thereof. These substances are given for illustrative purpose only and the additive to be added to the solution 300 in the present invention is not limited to the substances.

The mixture ratio between the solvent and the solute in the solution 300 is different depending on the types of the selected solvent and the selected solute. A desirable amount of solvent accounts for approximately 60 to 98 weight percent. A preferable amount of solute accounts for 5 to 30 weight percent.

Next, the effusing body 115 is set at a positive high voltage or a negative high voltage using the drawing power supply 123 (charging power supply 122). Charges concentrate at the tip part of the effusing body 115 facing the drawing electrode 121 (charging electrode 128) that is grounded, and the charges transfer to the solution 300 which effuses through the effusing holes 118 into space, so that the solution 300 is charged (a charging step).

The charging step and the supply step are simultaneously performed so that the solution 300 charged effuses from the end openings 119 of the effusing body 115 (an effusing step).

Next, the solution 300 flying in space for a certain distance is electrostatically stretched so that the nanofibers 301 are produced (a nanofiber producing step).

In this state, the nanofibers 301 fly toward the drawing electrode 121 (charging electrode 128) along the electric field generated between the effusing body 115 and the drawing electrode 121 (charging electrode 128), the nanofibers 301 are then deposited onto the substrate layer 200 and collected (a deposition step).

When sufficient nanofibers 301 are deposited, the collecting device 129 is activated and moves the deposition member 201 so that the deposited nanofibers 301 are collected with the deposition member 201 (a collection step).

When the method of manufacturing nanofibes is implemented using the nanofiber manufacturing apparatus 100 as described above, the insulating layer 101 deters the charges charged in the deposited nanofibers 301 from locally flowing into the drawing electrode 121 (charging electrode 128) so that the deposit of the nanofibers 301 (unwoven fabric) having an even quality can be obtained, even in the situation that the thickness of the substrate layer 200 increases as the nanofibers 301 are deposited. Furthermore, by setting the thickness resistance values of the insulating layer 101 to be sufficiently high and even, nanofibers 301 can be deposited with less influence from the nanofibers 301 deposited earlier, so that the deposit of the nanofibers 301 (unwoven fabric) having an even quality can be obtained in the deposition region A, even when the nanofibers 301 are thickly deposited.

### Embodiment 2

The following describes Embodiment 2 according to the present invention with reference to the drawings. The nanofiber manufacturing apparatus 100 according to the present invention is an apparatus in which the nanofibers 301 are directly deposited onto the insulating layer 101. The nanofiber manufacturing apparatus 100 includes the drawing electrode 121 and the charging electrode 128 separated from each other, and the potential applied to the drawing electrode 121 and the charging electrode 128 can be independently adjusted.

The present embodiment also illustrates an example of the present invention and one of varieties of the nanofiber manufacturing apparatus 100 that is possible to achieve the present invention, as is the same as in Embodiment 1 above. Accordingly, it goes without saying that the effusing body 115 having plural nozzles in an array shown below may be replaced by the effusing body 115 described in Embodiment 1 (including the storage tank 113 and plural effusing holes 118 provided in an array connected in common thereto). That is, an essential feature of the present invention is the insulating layer 101 arranged on the surface of the drawing electrode 121, and difference in other constituent elements does not affect the present invention. Accordingly, even the nanofiber manufacturing apparatus 100 shown in the present embodiment may have the drawing electrode 121 having the function of the charging electrode 128 as shown in Embodiment 1.

As described above, it seems that there are a very large number of embodiments that are possible to achieve the present invention. Because it is not possible to illustrate all of the embodiments, the following describes another nanofiber manufacturing apparatus 100 in which different constituent elements from Embodiment 1 are adopted. However, the rim of the present invention should be defined by the meaning of the wording described in the claims and the present invention is not determined by the description below.

Furthermore, the constituent elements having the same functions as those in Embodiment 1 are denoted by the same numerals and not explained.

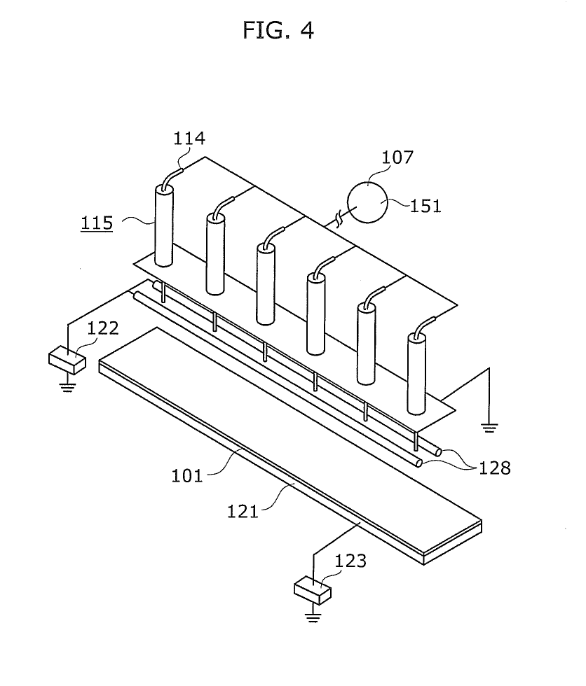

FIG. 4 is a perspective view illustrating the nanofiber manufacturing apparatus.

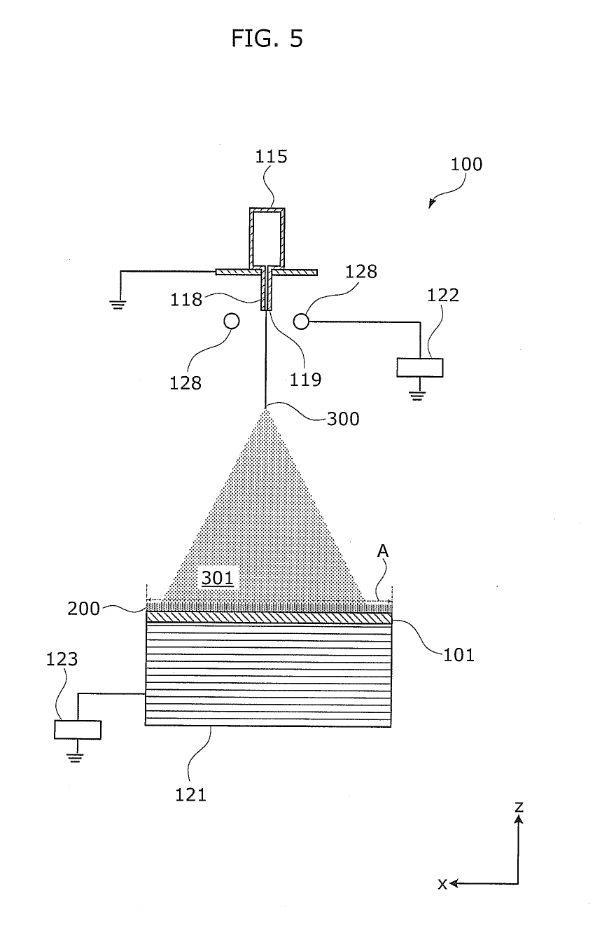

FIG. 5 is a side view illustrating a cutaway of a part of a main portion of the nanofiber manufacturing apparatus.

As shown in the drawings above, the nanofiber manufacturing apparatus 100 includes the effusing body 115 including the plural nozzles arranged in an array. Near the tip openings 119 of the nozzles arranged in an array, the charging electrode 128 in a round bar form is arranged.

In the present embodiment, two charging electrodes 128 are arranged near the tip openings 119 of the effusing holes 118 along the array of the nozzles. By arranging the charging electrodes 128 near the tip openings 119 of the effusing holes 118 as described above, the voltage applied between the effusing body 115 and the charging electrodes 128 can be set at a relatively low value.

The drawing electrode 121 is a conductive member in a rectangular plate form. The insulating layer 101 is provided on the surface of the drawing electrode 121 and throughout a surface facing the effusing body 115. The characteristics, such as the property and the material, of the insulating layer 101 according to the present embodiment are the same as the characteristics of the insulating layer 101 in Embodiment 1 above.

The drawing power supply 123 is a power supply that can generate an electric field that can draw the nanofibers 301 produced in space into the deposition region A, from the drawing electrode 121.

As described above, even in the nanofiber manufacturing apparatus 100 which includes the insulating layer 101 on the surface of the drawing electrode 121 that (i) hardly contributes to charging of the solution 300 and (ii) mainly draws the nanofibers 301 produced in space, the insulating layer 101 deters the charges charged in the deposited nanofibers 301 from locally flowing into the drawing electrode 121 (charging electrode 128) so that the deposit of the nanofibers 301 (unwoven fabric) having an even quality can be obtained, even in the situation that the thickness of the substrate layer 200 increases as the nanofibers 301 are deposited. Furthermore, by setting the thickness resistance values of the insulating layer 101 to be sufficiently high and even, nanofibers 301 can be deposited with less influence from the nanofibers 301 deposited earlier, so that the deposit of the nanofibers 301 (unwoven fabric) having an even quality can be obtained in the deposition region A, even when the nanofibers 301 are thickly deposited.

Furthermore, in the nanofiber manufacturing apparatus 100 according to the present embodiment, the potential applied to the drawing electrode 121 can be set at a relatively lower value than in Embodiment 1, so that material having relatively low dielectric strength can be adopted as a material for the insulating layer 101. Accordingly, it is possible to provide a wider range of selection for the material for the insulating layer 101.

It is to be noted that the present invention is not determined by the above embodiment. For example, in another embodiment of the present invention, the constituent elements described in the present description may be optionally combined. Any variations of the present embodiment to be conceived by those skilled in the art without departing from the spirit of the present invention, that is, the meaning of the wording in the claims, are also within the scope of the present invention.

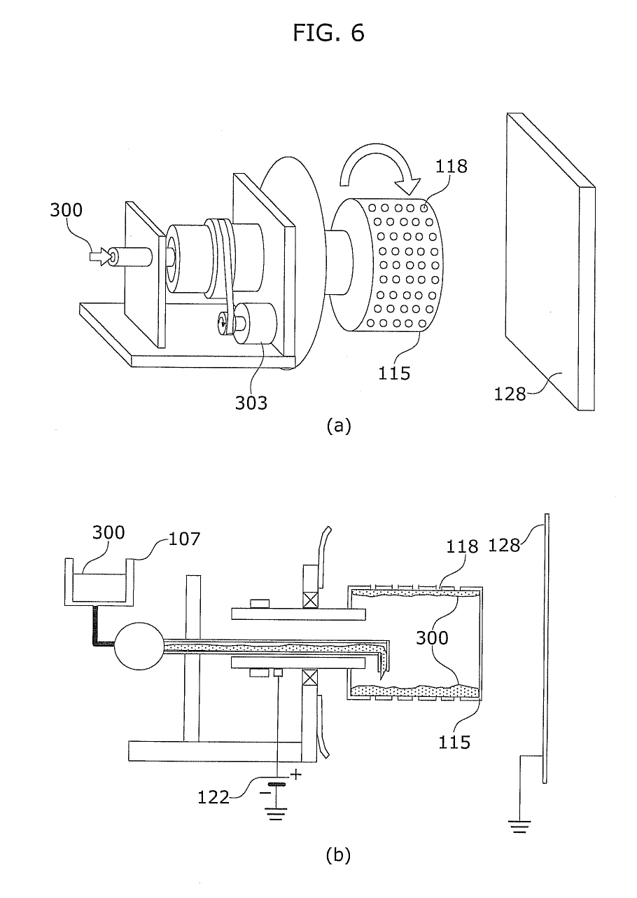

For example, a modification in which the deposition member 201 is applied to a nanofiber manufacturing apparatus 100 including the drawing electrode 121 and the charging electrode 128 separated from each other is also included in the present invention. Furthermore, as shown in FIG. 6, the effusing body 115 may be cylindrical, provided with the effusing holes 118 on its outer peripheral wall, and effuse the solution 300 into space using centrifugal force generated through rotation of the effusing body 115 by rotational driving force of the motor 303.

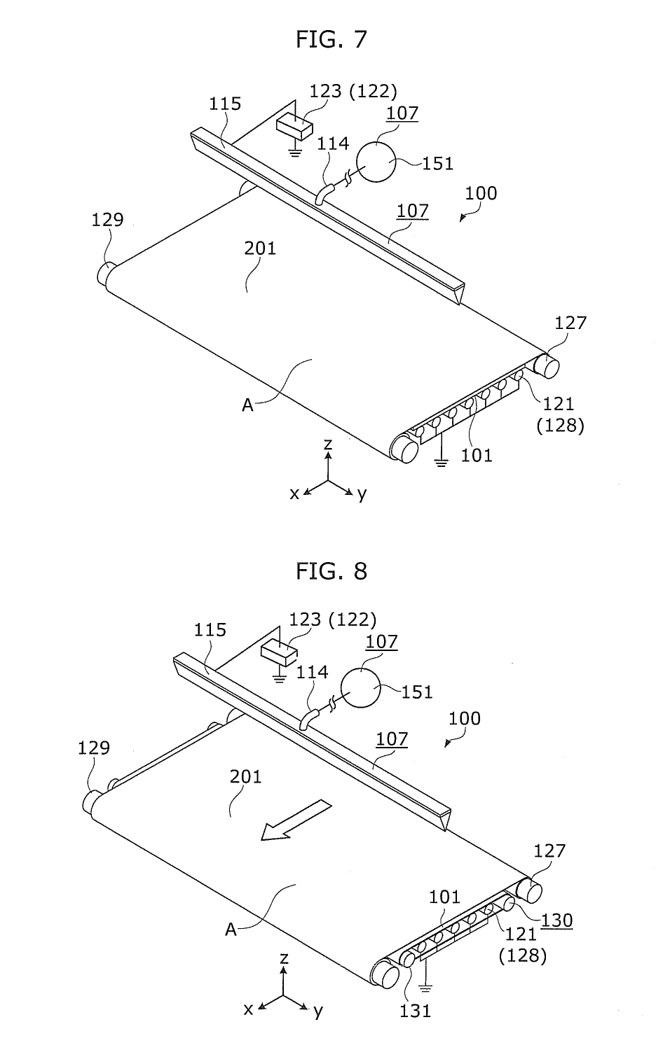

As shown in FIG. 7, the drawing electrode 121 (charging electrode 128) is not limited to be integrated and may be separated into plural electrodes. In this case, the insulating layer 101 is an insulating member in a flat plate form, and is arranged over the whole drawing electrodes 121 that are separated.

### Embodiment 3

The following describes Embodiment 3 according to the present invention with reference to the drawings.

FIG. 8 is a perspective view illustrating the nanofiber manufacturing apparatus 100 according the present embodiment.

As shown in the drawing, the nanofiber manufacturing apparatus 100 includes (i) an insulating layer 101 in an endless belt form, (ii) a rotation device 130 that movably holds the insulating layer 101 in the endless belt form in a rotating state, and (iii) the substrate layer 200 which is: a deposition member 201 which serves as a substrate layer 200 onto which the produced nanofibers are deposited and which is arranged on the surface of the insulating layer 101 so as to cover the deposition region A and moves with the insulating layer 101. The member or the device having the same functions as those in Embodiment 1 or Embodiment 2 are denoted by the same numerals and not explained.

In the present invention, the insulating layer 101 is formed by connecting the edge portions of the member in the sheet form so as to make the insulating layer 101 in an endless belt form. A specific preferred example includes a core which secures the structural strength and is coated by an insulating resin. Although the material for the core is not specifically limited, fabric made of polyester is raised as an example. As for the material used for coating to improve the insulation performance, silicon rubber, polypropylene, and vinyl chloride are raised as an example.

In the present invention, the rotation device 130 includes two rollers 131 which stretch the insulating layer 101 with applying a certain tension and hold the insulating layer 101 to be rotatable toward the direction indicated by an arrow in the drawing. In the present embodiment, the rollers 131 are non-powered rollers that are freely rotatable around its axis. The rollers 131 are not limited to non-powered rollers but may be powered rollers which actively rotate the insulating layer 101. The rollers 131 may also function as the drawing electrode 121.

In the same manner as in the above embodiments, in the present embodiment also, the substrate layer 200 includes the deposition member 201 for collecting the deposited nanofibers 301. The deposition member 201 is provided in a state being rolled around the supplying role 127, and can be moved by being rolled by a collecting device 129 in a direction indicated by an arrow in the drawing.

The drawing electrode 121 is arranged (i) to be surrounded by an orbit of the insulating layer 101 and (ii) at a position that the insulating layer 101 can be interposed between the deposition member 201 and the drawing electrode 121. The drawing electrode 121 includes plural cylindrical members which can rotate following the move of the insulating layer 101.

With the above structure, the friction strengthened by an electrical attraction generated between the insulating layer 101 and the deposition member 201 (substrate layer 200) is minimized because the insulating layer 101 can move in a rotating state following the move of the deposition member 201, so that the insulating layer 101 and the deposition member 201 are suppressed from being damaged due to the friction. Accordingly, the insulating layer 101 is deterred from being worn so that the life of the nanofiber manufacturing apparatus 100 is extended and the collected nanofibers 301 can be kept in a high quality.

The relationship among the insulating layer 101, the drawing electrode 121, and the deposition member 201 is not limited to the above and various varieties can be presented.

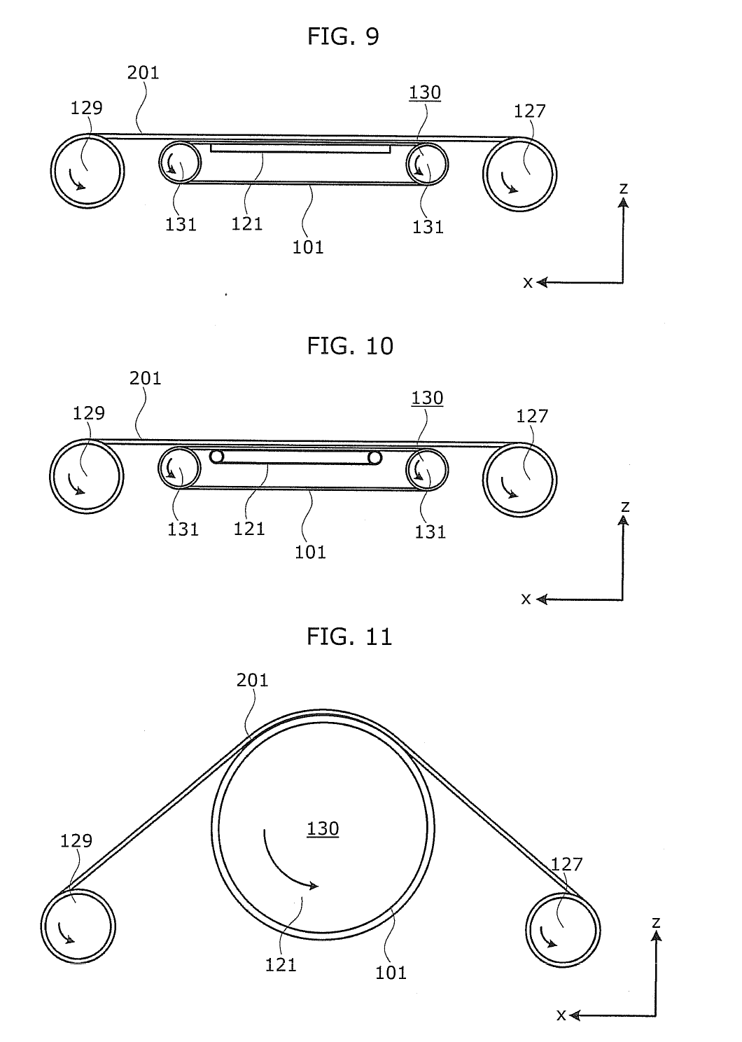

For example, as shown in FIG. 9, the drawing electrode 121 may be a fixed member in a plate-like form.

When such a structure is adopted, it is possible to draw the nanofibers 301 in a wide range.

Furthermore, as shown in FIG. 10, the drawing electrode 121 may be an endless belt which includes a conductive member in a flexible sheet form, and such a drawing electrode 121 may be made movable by two rollers in the same manner as with the insulating layer 101.

When this structure is adopted, the nanofibers 301 can be drawn into a wide range in the same manner as in FIG. 9, and the friction with the insulating layer 101 can be alleviated.

Furthermore, as shown in FIG. 11, it is also allowed to form the drawing electrode 121 as a big roller, place the insulating layer 101 on the surface of the drawing electrode 121, and synchronize the drawing electrode 121 and the insulating layer 101 with the move of the deposition member 201 to rotate.

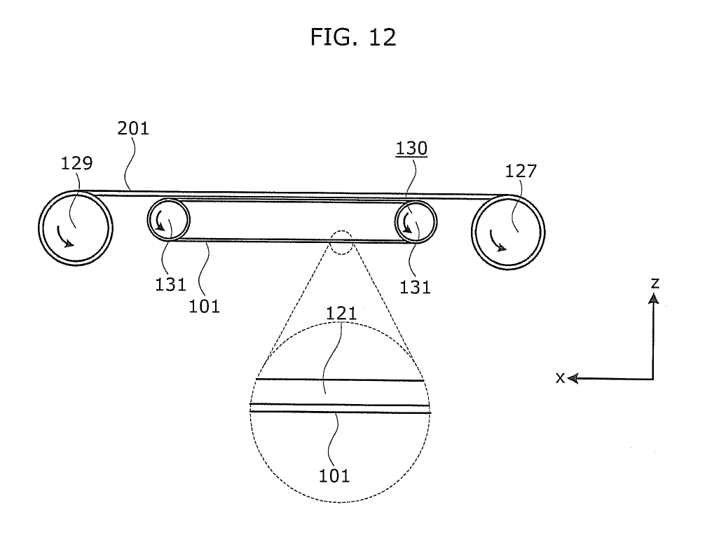

Moreover, as shown in FIG. 12, it is also allowed to place the insulating layer 101 on the surface of the drawing electrode 121 in the endless belt form that is flexible and conductive, and set the drawing electrode 121 at a given potential through the rollers 131.

### INDUSTRIAL APPLICABILITY

The present invention is applicable to spinning and manufacture of unwoven fabric using nanofibers.

### REFERENCE SIGNS

100 Nanofiber manufacturing apparatus
101 Insulating layer
107 Supplying device
113 Storage tank
114 Guide tube
115 Effusing body
118 Effusing hole
119 Tip opening
121 Drawing electrode
122 Charging power supply
123 Drawing power supply
125 Fastening member
127 Supplying role
128 Charging electrode
129 Collecting device
151 Container
200 Substrate layer
201 Deposition member
300 Solution
301 Nanofibers
303 Motor

1. A nanofiber manufacturing apparatus which produces nanofibers by electrically stretching in space a solution for manufacturing nanofibers, said apparatus comprising:
a drawing electrode which generates an electric field that draws the nanofibers produced in space, said drawing electrode having, on a surface, a planar deposition region onto which the drawn nanofibers are deposited;
a drawing power supply which applies a given potential to said drawing electrode;
an insulating layer which suppresses variation in resistance values of the nanofibers deposited in the deposition region, and is placed throughout the deposition region; and
a deposition member onto which the nanofibers are deposited, which is in a sheet form and movably arranged on a surface of said insulating layer so as to cover the deposition region.

2. The nanofiber manufacturing apparatus according to claim 1,
wherein said insulating layer and said deposition member satisfies (rmax−rmin)/R≦0.3,
where rmax is the maximum value of “total thickness resistance values”,
rmin is the minimum value of the total thickness resistance values in the deposition region, and
R is an average value of the total thickness resistance values in the deposition region,
the “total thickness resistance values” being resistance values in a thickness direction of both said insulating layer and said deposition member.

3. (canceled)

4. The nanofiber manufacturing apparatus according to claim 1,
wherein said insulating layer includes a substance having a volume resistivity greater than or equal to 1×10̂15 (Ω·cm).

5. The nanofiber manufacturing apparatus according to claim 4,
wherein said insulating layer includes the substance having a dielectric strength greater than or equal to 20 (kV/mm).

6. The nanofiber manufacturing apparatus according to claim 1,
wherein the volume resistivity of the substance included in said insulating layer is equal to or greater than ten times the volume resistivity of a substance included in the nanofibers or a substance included in said deposition member.

7. The nanofiber manufacturing apparatus according to claim 1,
wherein thickness resistance values that are resistance values of said insulating layer in a thickness direction is equal to or greater than ten times a volume resistivity of the nanofibers or said deposition member.

8. The nanofiber manufacturing apparatus according to claim 1,
wherein said insulating layer is in an endless belt form,
said nanofiber manufacturing apparatus further comprises a rotation device which movably holds said insulating layer in the endless belt form in a rotating state, and
said deposition member moves with said insulating layer.

9. A method of manufacturing nanofibes by electrically stretching in space a solution for manufacturing nanofibers, said method comprising:
applying, by a drawing power supply, a given potential to a drawing electrode so that the nanofibers produced in space are drawn into a deposition region onto which the nanofibers are deposited, the drawing electrode having an insulating layer which suppresses variation in resistance values of the nanofibers deposited in the deposition region, and is placed throughout the deposition region; and
depositing nanofibers onto a deposition member which is in an insulating sheet form and movably arranged on a surface of said insulating layer so as to cover the deposition region.
